(19) United States
(12) Patent Application Publication
(10) Pub. No.: US 2011/0193539 A1
(43) Pub. Date: Aug. 11, 2011

(54) Switching Regulator with Offset Correction

(75) Inventors: Thomas A. Schmidt, Murphy, TX (US); Robert Martinez, Lucas, TX (US); Wenliang Chen, Plano, TX (US); Wei-Chung Wu, Richardson, TX (US)

(73) Assignee: TEXAS INSTRUMENTS INCORPORATED, Dallas, TX (US)

(21) Appl. No.: 12/703,725

(22) Filed: Feb. 10, 2010

(51) Int. Cl. G05F 1/10

(52) U.S. Cl. 323/282

(57) ABSTRACT

A switching regulator generally includes an output circuit, a comparator, an on-time timer and an error amplifier. The output circuit receives an input voltage and produces an output voltage. The comparator causes the output circuit to turn on the output voltage when a feedback voltage falls below a first reference voltage. The on-time timer causes the output circuit to turn off the output voltage after a time-out period. The error amplifier receives the feedback voltage and a second reference voltage and produces the first reference voltage.

### CROSS REFERENCE TO RELATED APPLICATIONS

This application claims the benefit of U.S. Provisional Application No. 61/151,225, filed Feb. 10, 2009. The aforementioned application is assigned to an entity common hereto, and the entirety of the aforementioned application is incorporated herein by reference for all purposes.

### BACKGROUND OF THE INVENTION

A switching regulator is generally used to supply a relatively constant voltage to power an electronic device and/or recharge a battery in the device. Some of these switching regulators are referred to as DC-to-DC, PWM, PFM, Burst, or Hysteretic type switching regulators or controllers.

Some typical switching regulators cycle, or switch, between on and off times for applying an input voltage across an inductor to generate an output voltage. (The rate at which a switching regulator cycles through these on and off times is the frequency of the switching regulator.) In this manner, the output voltage is regulated to approximately a desired voltage level or within a desired range. The desired voltage level is determined by the voltage requirements for operating the circuit components of the electronic device, including recharging the battery if present.

Whereas the switching regulator of an electronic device must generally maintain the output voltage at approximately a desired voltage level or within a desired range, the switching regulator also must be able to change the output current to satisfy changing current demands of the electronic circuitry. The electrical current demands can change when various different sub-circuits within the electronic device are activated and deactivated according to the functions of the device. In order to maintain proper functioning of all of the electronic circuits in the device, the voltage must be held relatively steady while the current is changed relatively rapidly. The speed with which the switching regulator can respond to fluctuating demands is generally referred to as the transient response time. Propagation delays of components within the switching regulator generally determine the transient response time.

Due to the on and off cycling and the propagation delays in the circuitry of the switching regulator, there is an inherent ripple, sometimes referred to as an “offset,” or “DC offset,” in the output voltage. This offset varies depending on input voltage, output voltage, inductance, output capacitor ESR, temperature and load, among other relevant factors. The “accuracy” of the switching regulator is generally characterized by the maximum swing of this offset from the desired voltage level over the operating range of the switching regulator.

Sometimes, after determining the expected operating characteristics (e.g. anticipated load conditions) of a given design, a fixed offset is added to the circuit to compensate for the inherent offset of the switching regulator. For example, some compensation for, or minimization of, a portion of the offset can be achieved by adjusting the manufacturing process (e.g. integrated circuit fabrication) of the switching regulator. However, this solution also often requires a continuous-to-discontinuous detector or PWM-to-PFM detector, which can add to the complexity and degrade the performance of the circuitry.

An important trend regarding electronic circuits is to increase the number of components (and thus the functionality of the circuit) while decreasing, or at least not increasing, the space that the circuitry occupies. Fortunately, a switching regulator operating at a higher frequency allows for smaller components (e.g. inductor and capacitor) at the output of the switching regulator. However, as these components get smaller and the frequency gets higher, the inherent offset in the output voltage gets worse, generally because the effect of the propagation delays becomes more relevant or noticeable at higher frequencies. Thus, the accuracy of the switching regulator may suffer, which is a significant detriment, since another important trend regarding electronic circuits generally requires increased accuracy in the voltage generated by the switching regulator. This accuracy requirement is particularly important for circuits that include a rechargeable Li-Ion battery, due to safety issues regarding the chemistry of such batteries. However, design enhancements that improve the accuracy of a switching regulator often have a negative effect on the transient response time due to the presence of additional components, which introduce additional propagation delays, in the circuitry.

A switching regulator having a relatively fast transient response time with a relatively high accuracy is the D-CAP™ fixed minimum on-time family of controllers available from Texas Instruments Incorporated. Depending on the implementation, a D-CAP controller can achieve about a 100 nanosecond transient response time with an accuracy of about 2-3% (a lower percent indicating a greater accuracy). A design based on D-CAP generally reduces the number of external output capacitors (e.g. by as much as 32%) compared to competing devices. It can also eliminate the need for external loop compensation. D-CAP, thus, provides ease of use, low external component count and a fast transient response.

The above mentioned trends, however, are squeezing switching regulator designs beyond the capabilities of existing D-CAP solutions with respect to physical space and overall performance. In fact, for some applications (e.g. Li-Ion battery charging in cell phones, PDAs and notebook computers) the control needs to be much more accurate (e.g. less than 0.5%), while achieving a relatively fast transient response in a relatively small physical form factor.

### BRIEF DESCRIPTION OF THE DRAWINGS

FIG. 1 is a simplified schematic diagram of a switching regulator incorporating an embodiment of the present invention.

FIG. 2 is a simplified schematic diagram of a regulation sub-circuit for use in the switching regulator shown in FIG. 1, according to an embodiment of the present invention.

FIG. 3 is a simplified schematic diagram of an output sub-circuit for use in the switching regulator shown in FIG. 1, according to an embodiment of the present invention.

FIG. 4 is a simplified schematic diagram of an On-Time Timer sub-circuit for use in the switching regulator shown in FIG. 1, according to an embodiment of the present invention.

FIG. 5 is a simplified schematic diagram of another switching regulator incorporating an alternative embodiment of the present invention.

FIG. 6 is a simplified schematic diagram of another output sub-circuit for use in the switching regulator shown in FIG. 5, according to an alternative embodiment of the present invention.

FIG. 7 is a simplified schematic diagram of another regulation sub-circuit for use in the switching regulator shown in FIG. 5, according to an alternative embodiment of the present invention.

FIG. 8 is a simplified graph of an output voltage vs. a load current for a switching regulator (such as the switching regulator shown in either FIG. 1 or FIG. 5) incorporating an embodiment of the present invention, compared to a similar graph for a prior art switching regulator.

### DETAILED DESCRIPTION OF THE INVENTION

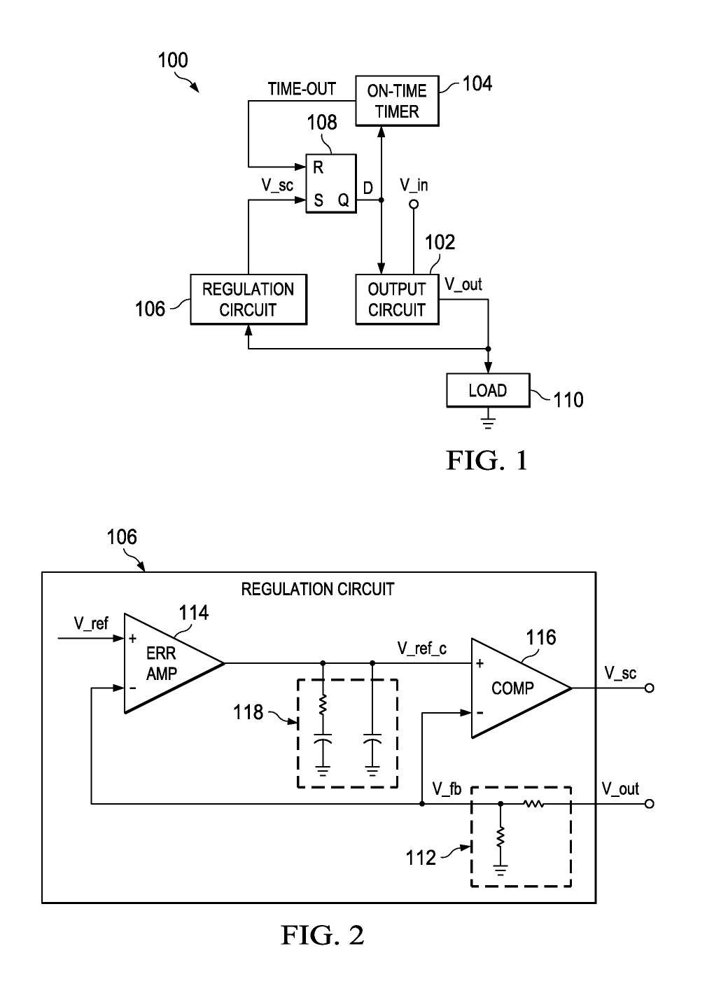

A simplified switching regulator 100 incorporating an embodiment of the present invention, preferably for use in an electronic device involving a relatively small form factor, a relatively fast transient response and a relatively high accuracy, is shown in FIG. 1. The switching regulator 100 generally includes components 102-108 that function to supply an output voltage (V_out) to the rest of the circuitry of the electronic device, represented by a load 110. The switching regulator 100 can achieve a relatively high accuracy, on the order of about 0.5% or less, in some embodiments, so the load 110 can include a rechargeable battery, such as a Li-Ion battery. Additionally, the switching regulator 100 preferably includes some features of D-CAP™ in some embodiments, so it can achieve a relatively fast transient response in a relatively small form factor.

U.S. patent application Ser. No. 11/256,869, filed Oct. 24, 2005, and U.S. patent application Ser. No. 12/367,384, filed Feb. 6, 2009, both describe various features that may be part of a device based on a D-CAP design. These applications are assigned to an entity common hereto, and the entireties of these applications are incorporated herein by reference for all purposes. Similar to these applications, various embodiments of the present invention may incorporate a minimum off-time timer, a time-out timer and an on-time shaver and/or a zero crossing comparator, in addition to other features.

According to the embodiment illustrated in FIG. 1, the components of the switching regulator 100 generally include an output circuit 102, an On-Time Timer 104, a regulation circuit 106 and a latch 108. Under control of the other components 104-108, the output circuit 102 generates the desired output voltage V_out from an input voltage V_in, as described below.

Other circuitry (not shown) may also be included in or connected to the switching regulator 100. For example, a programmable general-purpose microcontroller or an application-specific integrated circuit (ASIC) may be included in the electronic device in order to control various settings or functions of the switching regulator 100. Such control, for instance, may include setting the voltage level to which the output voltage V_out is regulated for different operating conditions, e.g. at initial power-up, during normal operations, etc.

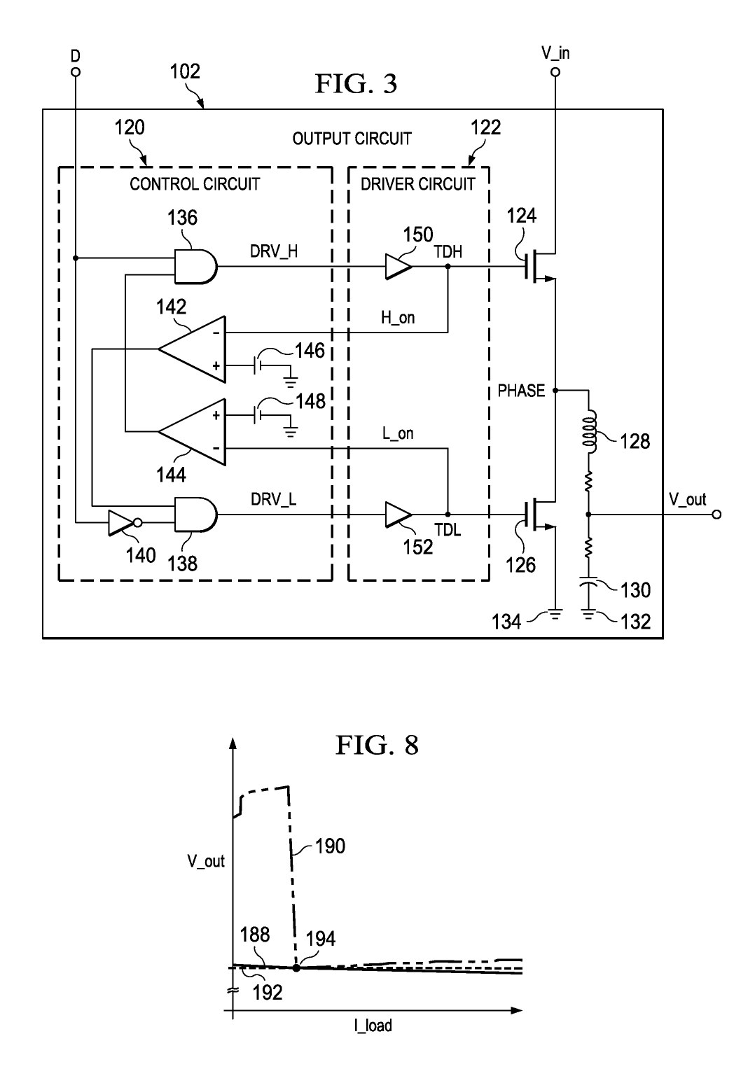

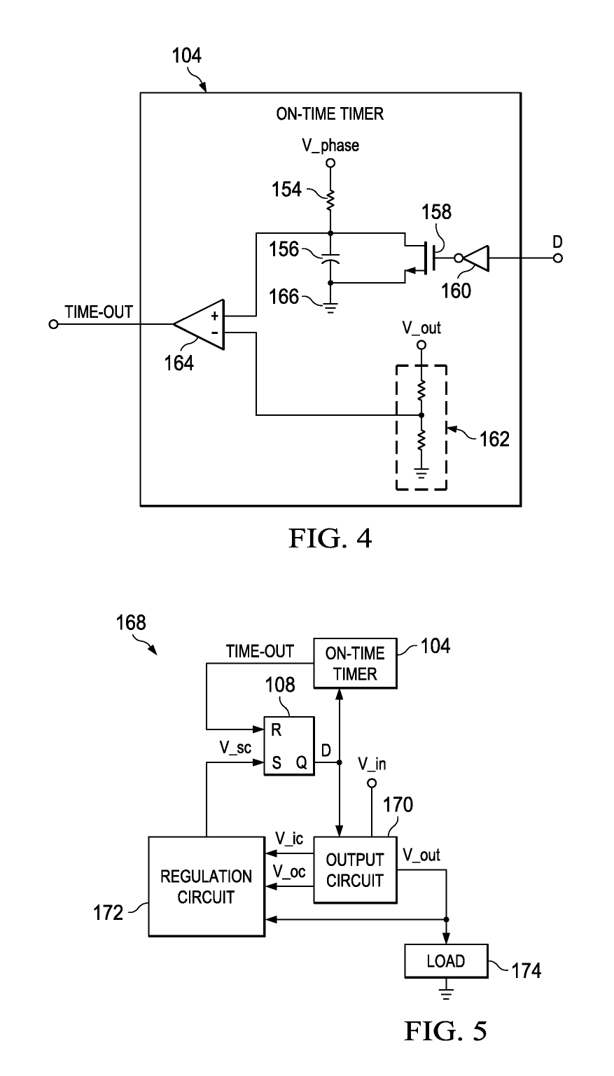

According to the illustrated embodiment, the regulation circuit 106 receives the output voltage V_out and generates a switching control voltage V_sc, as described below with reference to FIG. 2. The latch 108 (represented in this embodiment as an S-R flip-flop) receives the switching control voltage V_sc at a set (S) input and an output of the On-Time Timer 104 at a reset (R) input and generates a control voltage, or switching signal, (D). The On-Time Timer 104 receives the control voltage D and outputs a time-out control voltage (Time-Out), as described below with reference to FIG. 4. The output circuit 102 receives the control voltage D and the input voltage V_in and generates the output voltage V_out, as described below with reference to FIG. 3.

In this embodiment, the regulation circuit 106, as described below with reference to FIG. 2, causes the latch 108 to set (e.g. turn on, activate or produce) the control voltage D when the output voltage V_out decreases below a desired minimum level. In response to activating the control voltage D, the output circuit 102 increases power to the output voltage V_out, as described below with reference to FIG. 3. The On-Time Timer 104, on the other hand, responds by starting to time a time-out period, as described below with reference to FIG. 4. Upon reaching the end of the time-out period, the On-Time Timer 104 generates the Time-Out control voltage to cause the latch 108 to reset (e.g. turn off, deactivate or stop producing) the control voltage D. In response to deactivating the control voltage D, the output circuit 102 decreases power to the output voltage V_out, as described below. The regulation circuit 106, as a relatively fast feedback control loop, then responds to the resultant decrease in the output voltage V_out in order to repeat this cycle.

In the manner described, the switching regulator 100 generally has a relatively constant “on-time”, similar to a D-CAP-based design. (Optionally, additional circuitry may be incorporated to limit the on-time period, e.g. when the switching regulator 100 operates within certain portions of its operating range.) Consequently, the switching regulator 100 does not regulate the output voltage V_out to a maximum voltage level by turning off the control voltage D when the output voltage V_out increases above a desired maximum level. Therefore, since the regulation circuit 106 has to respond only when the output voltage V_out decreases below a desired minimum level, it can be designed (like a D-CAP-based device) to respond much more quickly than can a regulation circuit that responds to changes in an output voltage in a hysteretic manner to both activate and deactivate an output circuit. (The following is a non-exhaustive description of D-CAP-based designs and features.)

Other features and advantages common to D-CAP that may be incorporated in embodiments of the present invention may be apparent since D-CAP-based devices are often referred to as pseudo constant on-time PFM type switching regulators or synchronous buck controllers or synchronous switcher controllers or adjustable-output buck converters. Depending on implementation, a D-CAP-based device is commonly a voltage controller that has a near-constant on-time that is essentially based on the ratio of its output voltage to its input voltage. Additionally, it has a very fast (on the order of about 100 nanoseconds) load-step transient response time. It is typically relatively simple and reduces the number of external components, such as output capacitors, (e.g. by as much as 32%) compared to competing devices. It can also eliminate the need for external loop compensation and has a relatively low standby power consumption compared to comparable switching regulators. Some D-CAP-based devices have a fixed-frequency emulated adaptive on-time control that supports relatively seamless operation between a PWM mode at heavy load condition and reduced frequency operation at light load for high efficiency down to milliamp range. It can also allow the frequency to vary as the output load changes. Additionally, it can be optimized for low ESR output capacitors. Furthermore, a D-CAP-based design typically includes a configuration to run in a “current mode,” e.g. to support ceramic output capacitors. D-CAP-based designs, thus, provide ease of use, low external component count, low cost and fast transient response.

As an example, a D-CAP device can run a fixed 400 kHz pseudo-constant frequency PWM with an adaptive on-time control that can be configured for ease of use and fast transient response. As another example, a D-CAP device can be a synchronous switcher with a 2-Amp, source-only low drop-out (LDO) regulator. As a further example, it can be specifically designed for low cost/low noise/low external-component count power systems for applications such as GPUs (graphic processing units). It can also be used as a cost effective solution for notebook power bus regulators. D-CAP designs can be used in embedded PCs, mobile communications applications and notebooks, as well as base stations and network attached storage applications, among other devices. D-CAP can power DSPs, FPGAs, ASICs, I/O and DDR memory cores. It can also have integrated MOSFETs. It can serve as a 1-MHz DC/DC switcher. It can use an “auto-skip” mode and “light-load” control schemes to help meet Energy Star/90 Plus guidelines. Some examples can use an input voltage from 3 to 14 V and can produce an output voltage range from 0.75 to 5.5 V. Additionally, in some examples, it supports designs for 3.3-, 5-, and 12-V power systems. It can be a selectable dual- or single-phase, fully IMVP-6+ spec-compliant step-down controller with integrated gate drivers. It can be used in low-power CPUs and Intel™ integrated graphics solutions for IMVP-6+ generation notebook systems. It can also have an integrated boost switch to enhance a high-side MOSFET to further improve efficiency.

A D-CAP device, depending on the implementation, also typically operates outside of an audible frequency range under light current load conditions with reduced switching frequency by reducing supply current and regulating output voltage. In this case, it preferably maintains the switching frequency above an audible frequency range and reduces supply current by modulating switch on-time, sinking supply current or permitting negative supply current values. The output voltage is typically regulated by modulating switch on-time, clamping output voltage or modifying feedback detector thresholds. Thus, under this example, it operates with improved efficiency under light current load conditions, while avoiding operation in an audible frequency range to prevent the generation of audible noise in converter components.

According to an embodiment shown in FIG. 2, the regulation circuit 106 generally includes a feedback voltage generator 112, an error amplifier 114, a comparator 116 and a compensation circuit 118. The feedback voltage generator 112 receives the output voltage V_out and generates a feedback voltage V_fb. The error amplifier 114 receives the feedback voltage V_fb at an inverting input and a reference voltage V_ref at a non-inverting input and generates an offset-corrected reference voltage V_ref_c. The comparator 116 receives the feedback voltage V_fb at an inverting input and the offset-corrected reference voltage V_ref_c at a non-inverting input and generates the switching control voltage V_sc. The compensation circuit 118 (e.g. a resistor and capacitors) is interposed between the error amplifier 114 and the comparator 116.

The feedback voltage generator 112 may, for example, be a voltage divider circuit, as shown, or any other appropriate circuitry. Thus, with the output voltage V_out, the feedback voltage generator 112 produces the feedback voltage V_fb, which is representative of the level of the output voltage V_out.

The error amplifier 114 and the comparator 116 monitor the output voltage V_out via the feedback voltage V_fb. In this embodiment, the error amplifier 114 and the comparator 116 function together to generate the switching control voltage V_sc based on the feedback voltage V_fb and the reference voltage V_ref. The reference voltage V_ref is produced by any appropriate voltage generator circuitry and is at the desired voltage level to which the output voltage V_out (FIG. 1) is regulated by the feedback loop formed by the regulation circuit 106.

A general overall effect of the error amplifier 114 is to drive the feedback voltage V_fb to be about the same as the reference voltage V_ref. In other words, through negative feedback, the offset-corrected reference voltage V_ref_c is adjusted so that the feedback voltage V_fb is considerably closer to the reference voltage V_ref than it is in the prior art. If the feedback voltage V_fb changes, then the error amplifier 114 detects a change in a difference (positive or negative) between the feedback voltage V_fb and the reference voltage V_ref and alters the offset-corrected reference voltage V_ref_c in a manner that compensates for the offset (or a significant portion thereof) in the feedback voltage V_fb. As a result, the comparator 116 responds at a later or sooner time (depending on a positive or negative difference between V_fb and V_ref), since the feedback voltage V_fb will fall below the offset-corrected reference voltage V_ref_c within a different time period, due to the change made to V_ref_c. In other words, the error amplifier 114 automatically detects the DC offset component of the output voltage ripple and increases or decreases the offset-corrected reference voltage V_ref_c to minimize the DC offset error in the output voltage V_out. By automatically adjusting for the proper offset, variations on this embodiment also allow a PFM-only regulator topology, instead of a PWM/PFM dual controller, to be used, thereby avoiding the need for a PWM/PFM or continuous/discontinuous detector to reduce the DC regulation variation.

The error amplifier 114 preferably has a higher gain than the comparator 116 has. But the comparator 116 preferably has a faster response time than the error amplifier 114 has. As a consequence, the error amplifier 114 nulls out most of the offset in the output voltage V_out, e.g. down to better than 0.5% accuracy, without causing rapid fluctuations therein. Also, the compensation circuit 118 enhances the stability of the output of the error amplifier 114, since it takes longer for the output of the error amplifier 114 to settle, compared to the comparator 116. The comparator 116, on the other hand, responds quickly to changes in the output voltage V_out, e.g. with a transient response time of 100 nanoseconds or faster. Since the error amplifier 114 is slow relative to the comparator 116, the error amplifier 114 does not interfere with the rapid response function of the comparator 116. Since it has a higher gain, however, the error amplifier 114 results in a smaller error; and the higher the gain, the more accurate it becomes.

The output circuit 102, according to the embodiment shown in FIG. 3, generally includes a control circuit 120, a driver circuit 122, high side and low side MOSFET transistors 124 and 126, an inductor 128 and an output capacitor 130. The output voltage V_out is generated at a node between a low side of the inductor 128 and the output capacitor 130, which is further connected to ground (at 132). The resistors shown between the inductor 128 and the output capacitor 130 represent the inherent resistance, or equivalent series resistance (ESR), of these components.

The control circuit 120 and the driver circuit 122 function together in response to the control voltage D to generate high and low transistor drive voltages TDH and TDL, alternating between the two drive voltages. The high and low transistor drive voltages TDH and TDL drive the high side and low side transistors 124 and 126, respectively, generally as switches in a switching half bridge configuration. When the high transistor drive voltage TDH is activated, the high side transistor 124 is turned on, and the input voltage V_in is electrically connected to a phase node (Phase) on the high side of the inductor 128. (The Phase node is sometimes called the “switching node.”) When the low transistor drive voltage TDL is activated, the low side transistor 126 is turned on, and ground (at 134) is electrically connected to the Phase node.

When the input voltage V_in is connected to the Phase node, energy is stored in the inductor 128, while the output voltage V_out increases. When the ground (at 134) is connected to the Phase node, energy is released or discharged from the inductor 128, and the output voltage V_out decreases. In other words, when the input voltage V_in is applied to the high side of the inductor 128, the current in the inductor 128 ramps up. And when the high side of the inductor 128 is connected to ground (at 134), the current in the inductor 128 ramps down. This ramping up and down, or ripple, of the current causes an AC current component that goes through the output capacitor 130. The capacitance of the output capacitor 130 helps maintain the output voltage V_out relatively steady. However, the ESR of the output capacitor 130 creates a voltage drop that is proportional to the current ripple.

The ESR of a capacitor is basically a rating of quality. A theoretically perfect capacitor would be lossless and have an ESR of zero. Thus, it would have no in-phase AC resistance. In reality, however, all capacitors have some amount of ESR.

This embodiment (and typical designs based on D-CAP) generally uses the voltage drop due to the ESR of the output capacitor 130 to aid the relatively fast feedback loop, wherein the regulation circuit 106 (FIGS. 1 and 2) responds when the output voltage V_out decreases below a desired minimum level, to cause the setting of the control voltage D in order to control the switching on of the high side transistor 124 and the switching off of the low side transistor 126. The On-Time Timer 104, on the other hand, generally causes the resetting of the control voltage D in order to control the switching off of the high side transistor 124 and the switching on of the low side transistor 126.

In this embodiment, the control circuit 120 receives the control voltage D output from the latch 108 (FIG. 1) and generates high and low drive control voltages DRV_H and DRV_L. The driver circuit 122 receives the high and low drive control voltages DRV_H and DRV_L and generates the high and low transistor drive voltages TDH and TDL that drive the high side and low side transistors 124 and 126. The driver circuit 122 also generates high and low “on” voltages H_on and L_on that indicate when the high side and low side transistors 124 and 126, respectively, are turned on. The high and low “on” voltages H_on and L_on are provided back to the control circuit 120 for cross conduction control.

The control circuit 120 generally includes high and low AND gates 136 and 138, an inverter 140 and high and low comparators 142 and 144. The high AND gate 136 receives the control voltage D and the output of the low comparator 144 and, when both inputs are high, generates the high drive control voltage DRV_H. The low AND gate 138 receives the control voltage D inverted through the inverter 140 and the output of the high comparator 142 and, when both inputs are high, generates the low drive control voltage DRV_L. The output of the high comparator 142 is a logic high when the high “on” voltage H_on is below a threshold voltage 146, otherwise the output of the high comparator 142 is a logic low. On the other hand, the output of the low comparator 144 is a logic high when the low “on” voltage L_on is below a threshold voltage 148, otherwise the output of the low comparator 144 is a logic low.

The driver circuit 122 generally includes high and low drivers 150 and 152. The high driver 150 generates the high transistor drive voltage TDH in response to the high drive control voltage DRV_H. The high “on” voltage H_on is generated from the high transistor drive voltage TDH and indicates when the high transistor drive voltage TDH has turned on the high side transistor 124. Similarly, the low driver 152 generates the low transistor drive voltage TDL in response to the low drive control voltage DRV_L. And the low “on” voltage L_on is generated from the low transistor drive voltage TDL and indicates when the low transistor drive voltage TDL has turned on the low side transistor 126. (Additional components or logic, not shown, may be used to generate the high and low “on” voltages H_on and L_on.)

While the high transistor drive voltage TDH is activated, the high “on” voltage H_on causes the high comparator 142 to supply a logic low signal to the low AND gate 138. While the output of the high comparator 142 is a logic low, the low AND gate 138 cannot activate the low drive control voltage DRV_L. Thus, the low drive control voltage DRV_L remains deactivated, even after the control voltage D is deactivated, until the high transistor drive voltage TDH falls low enough that the high “on” voltage H_on falls below the threshold voltage 146, thereby causing the high comparator 142 to supply a logic high signal to the low AND gate 138. In other words, the high “on” voltage H_on and the high comparator 142 prevent the low AND gate 138 and the low driver 152 from turning on the low side transistor 126 until after the high side transistor 124 has been turned off. By a similar operation, the low “on” voltage L_on and the low comparator 144 prevent the high AND gate 136 and the high driver 150 from turning on the high side transistor 124 until after the low side transistor 126 has been turned off. In this manner, the output circuit 102 maintains cross conduction control between the high and low side transistors 124 and 126.

According to the embodiment illustrated in FIG. 4, the On-Time Timer 104 is an RC timer. Other types of timers, however, may be used in other embodiments of the present invention.

In this embodiment, the On-Time Timer 104 generally includes a resistor 154, a capacitor 156, a transistor 158, an inverter 160, a voltage divider 162 and a comparator 164. The output voltage V_out from the output circuit 102 (FIGS. 1 and 3) is supplied to the voltage divider 162. And the output of the voltage divider 162 is supplied to an inverting input of the comparator 164. The control voltage D is supplied to the inverter 160. The output of the inverter 160 drives the gate of the transistor 158. The transistor 158 is connected across the capacitor 156. The capacitor 156 is connected to ground at 166 and the resistor 154. A voltage (V_phase) is supplied to the other end of the resistor 154. A node between the capacitor 156 and the resistor 154 is connected to a non-inverting input of the comparator 164. The output of the comparator 164 is generally the Time-Out control voltage generated by the On-Time Timer 104.

The voltage V_phase generally powers the On-Time Timer 104. In this embodiment, the voltage V_phase is preferably the voltage at the Phase node of the output circuit 102 (FIG. 3) and is proportional to the input voltage V_in after IR drops through the high side transistor 124 (and any resistive components). Additionally, the voltage V_phase may be filtered by an RC filter to decrease voltage fluctuations. Other embodiments may use any other appropriate source to power the On-Time Timer 104.

When the control voltage D is deactivated (i.e. logic low), the inverter 160 outputs a logic high signal, which turns on the transistor 158. When the transistor 158 is turned on, it shunts the node between the capacitor 156 and the resistor 154 to ground at 166. The non-inverting input of the comparator 164, therefore, is held to a low voltage level when the control voltage D is deactivated. On the other hand, when the control voltage D is set (i.e. activated logic high), the inverter 160 outputs a logic low signal, which turns off the transistor 158. When the transistor 158 is turned off, the capacitor 156 and the resistor 154 form an RC circuit between the voltage V_phase and ground at 166. The voltage level at the non-inverting input of the comparator 164, therefore, increases according to the time constant of this RC circuit. In other words, the resistor 154 and the capacitor 156 form the RC timer, powered by the voltage V_phase and controlled by the transistor 158, the inverter 160 and the control voltage D.

The voltage output by the voltage divider 162 is preferably at a level above the low voltage level at which the non-inverting input of the comparator 164 is held when the control voltage D is deactivated. Thus, the comparator 164 holds the Time-Out control voltage deactivated when the control voltage D is deactivated. When the control voltage D is set (activated) and the transistor 158 is turned off, then the voltage level at the node between the capacitor 156 and the resistor 154 begins to rise. When the voltage level at the node between the capacitor 156 and the resistor 154 rises above the voltage output by the voltage divider 162, the comparator 164 activates the Time-Out control voltage. When the Time-Out control voltage is activated, the control voltage D is reset (deactivated) by the latch 108 (FIG. 1).

The time from the point at which the control voltage D is activated (by the regulation circuit 106, as described above) until the point at which the control voltage D is deactivated (by the On-Time Timer 104) is essentially the time-out period that determines the on-time. The time-out period for a given design incorporating this embodiment, therefore, is built into the design by selecting values for the capacitance of the capacitor 156, the resistance of the resistor 154 and the voltage level for the output of the voltage divider 162, depending on the voltage levels of the available voltage V_phase and the desired output voltage V_out, among other potential considerations.

Another simplified switching regulator 168 incorporating an alternative embodiment of the present invention, preferably for use in an electronic device involving a relatively small form factor, a relatively fast transient response and a relatively high accuracy, is shown in FIG. 5. The switching regulator 168 generally includes components 104, 108, 170 and 172 that function to supply an output voltage (V_out) to the rest of the circuitry of the electronic device, represented by a load 174. The switching regulator 168 can achieve a relatively high accuracy, on the order of about 0.5% or less, in some embodiments, so the load 174 can include a rechargeable battery, such as a Li-Ion battery. Additionally, the switching regulator 168 preferably includes some features of D-CAP in some embodiments, so it can achieve a relatively fast transient response in a relatively small form factor. Furthermore, various embodiments of the switching regulator 168 may include one or more features described above with respect to the switching regulator 100, except as described below. Generally, variations on this embodiment can be applied to any PFM, hysteretic or burst switching regulator topology.

In this embodiment, the On-Time Timer 104 and the latch 108 are preferably similar to the same-numbered components shown in FIGS. 1 and 4. The components of the switching regulator 168 also include, according to this embodiment, an alternative output circuit 170 and an alternative regulation circuit 172. The output circuit 170 generates the output voltage V_out from the input voltage V_in under control of the control voltage D. However, the output circuit 170 also preferably produces feedback voltages that are representative of an output current and an input current (V_oc and V_ic, respectively). Additionally, the regulation circuit 172 receives, not only the output voltage V_out, but also the output and input current feedback voltages V_oc and V_ic, in order to produce the switching control voltage V_sc. Thus, the regulation circuit 172 produces the switching control voltage V_sc in order to regulate the output voltage V_out according to multiple feedback loops, instead of just one feedback loop as described for embodiments according to FIGS. 1, 2 and 3, above.

Since the switching regulator 168 regulates its output in response to multiple feedback loops, this embodiment is particularly suited for use in a battery charger design. Battery chargers typically regulate not just the output voltage, but also the output current. In other words, during some portion of the battery charging procedure, the battery is charged with a relatively constant current. At other times, the battery is charged with a relatively constant voltage. (Current and voltage are not regulated at the same time. At any given time during the battery charging procedure, therefore, the switching regulator 168 will generally be regulating either current or voltage.) The amplifier 114 (FIGS. 2 and 7) enhances both portions of the battery charging procedure, since it eliminates or reduces the offset in the output voltage V_out during both voltage regulation and current regulation.

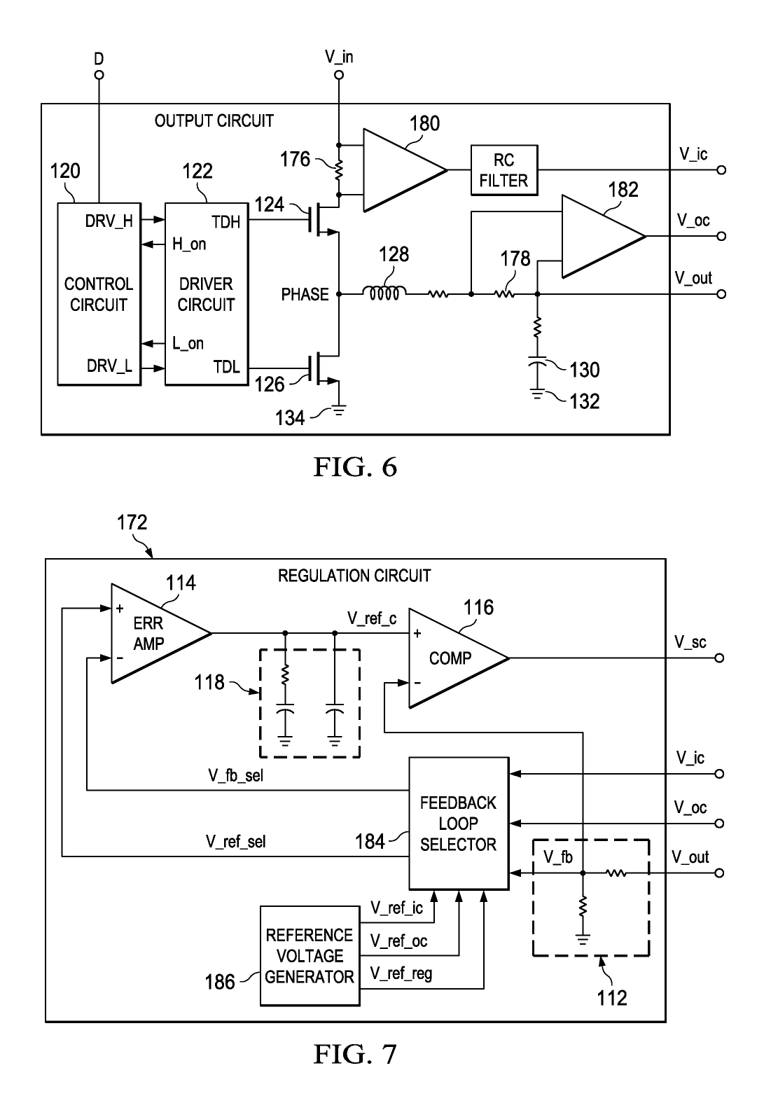

According to the embodiment shown in FIG. 6, the output circuit 170 generally includes the control circuit 120, the driver circuit 122, the high side and low side MOSFET transistors 124 and 126, the inductor 128 and the output capacitor 130, similar to the same-numbered components described above with reference to embodiments in accordance with FIG. 3. Additionally, these components 120-130 generally function similarly to the same-numbered components shown in FIG. 3. However, the output circuit 170 also generally includes two sense resistors 176 and 178 and two error amplifiers 180 and 182, with which the output and input current feedback voltages V_oc and V_ic are generated.

The output current feedback voltage V_oc is generated by error amplifier 182 and sense resistor 178. In particular, the inputs of the error amplifier 182 are connected to opposite ends of the sense resistor 178, so that the output of the error amplifier 182 (V_oc) is representative of the current through the sense resistor 178 and, thus, of the output current supplied to the load 174 (FIG. 5). Similarly, the input current feedback voltage V_ic is generated by error amplifier 180 and sense resistor 176. In particular, the inputs of the error amplifier 180 are connected to opposite ends of the sense resistor 176, so that the output of the error amplifier 180 (V_ic) is representative of the current through the sense resistor 176 and, thus, of the input current from the input voltage V_in. (Also, the output of the error amplifier 180 is preferably passed through an RC filter to form the input current feedback voltage V_ic.)

According to the embodiment shown in FIG. 7, the regulation circuit 172 generally includes the feedback voltage generator 112, the error amplifier 114, the comparator 116 and the compensation circuit 118, similar to the same-numbered components described above with reference to embodiments in accordance with FIG. 2. Additionally, these components 112-118 generally function similarly to the same-numbered components shown in FIG. 2. However, the regulation circuit 172 also generally includes a feedback loop selector 184 and a reference voltage generator 186.

The reference voltage generator 186 may be any appropriate circuitry for generating multiple voltages at desired voltage levels. In the particular embodiment shown, the reference voltage generator 186 generates an input current reference voltage V_ref_ic, an output current reference voltage V_ref_oc and a regulation reference voltage V_ref_reg. These reference voltages V_ref_ic, V_ref_oc and V_ref_reg are supplied to the feedback loop selector 184. Also, according to various embodiments, the reference voltage generator 186 may receive control signals from a microcontroller (not shown) within the switching regulator 168 or the overall electronic device (not shown) in order to set one or more of the reference voltages V_ref_ic, V_ref_oc and V_ref_reg to different desired voltage levels, depending on operating conditions of the switching regulator 168 or the overall electronic device.

The feedback voltage generator 112 generates the output feedback voltage V_fb from the output voltage V_out, as generally described above. The feedback loop selector 184 receives the output feedback voltage V_fb, the output and input current feedback voltages V_oc and V_ic and the reference voltages V_ref_ic, V_ref_oc and V_ref_reg. The feedback loop selector 184 generally compares the feedback voltages V_fb, V_oc and V_ic with the reference voltages V_ref_reg, V_ref_oc and V_ref_ic, respectively, to determine whether any of the corresponding feedback loops is experiencing a “triggering event” requiring setting the control voltage D and turning on power to the output of the switching regulator 168. Based on this determination, the feedback loop selector 184 produces a selected feedback voltage V_fb_sel and a selected reference voltage V_ref_sel.

The error amplifier 114 receives the selected feedback voltage V_fb_sel and the selected reference voltage V_ref_sel. The comparator 116 preferably receives the output feedback voltage V_fb and the selected reference voltage V_ref_sel. Alternatively, the comparator 116 may receive the selected feedback voltage V_fb_sel (with appropriate compensation circuit elements interposed) instead of the output feedback voltage V_fb. The error amplifier 114 and the comparator 116 generally function as described above.

An example implementation for the feedback loop selector 184, which can be modified for different numbers of feedback loops, is disclosed in U.S. patent application Ser. No. 10/995,742, filed Nov. 22, 2004. This application is assigned to an entity common hereto, and the entirety of this application is incorporated herein by reference for all purposes.

The embodiment shown in FIGS. 5, 6 and 7 uses three feedback loops. However, it is understood that the present invention is not so limited, but may be applied to any number of feedback loops. The three specific feedback loops shown enable the switching regulator 168 to regulate the output voltage V_out based, not only on the level of the output voltage V_out, but also on the levels of both the output current and the input current, in order to ensure safe and efficient operation of the overall electronic device. Other embodiments may use different sources for the feedback voltages from a variety of desired locations within the circuitry of the overall electronic device, depending on desired operating constraints thereof.

In a particular embodiment, if none of the feedback voltages V_fb, V_oc and V_ic is below its respective reference voltage V_ref_reg, V_ref_oc and V_ref_ic, then none of the corresponding feedback loops is experiencing a triggering event for setting the control voltage D and turning on power to the output of the switching regulator 168. Therefore, in this case, the feedback loop selector 184 outputs the selected feedback voltage V_fb_sel and the selected reference voltage V_ref_sel so that the error amplifier 114 and the comparator 116 do not cause the control voltage D to be set, or activated. In general, this result means that V_fb_sel and V_ref_sel are selected, or generated, such that the voltage level of V_fb_sel is above that of V_ref_sel, resulting in the comparator 116 outputting the switching control voltage V_sc as a logic low. In a specific example for this case, the output feedback voltage V_fb and the regulation reference voltage V_ref_reg may be effectively passed-through as the selected feedback voltage V_fb_sel and the selected reference voltage V_ref_sel.

In this embodiment, however, if one or more of the feedback voltages V_fb, V_oc and V_ic is below its respective reference voltage V_ref_reg, V_ref_oc and V_ref_ic, then at least one of the corresponding feedback loops is experiencing a triggering event for setting the control voltage D and turning on power to the output of the switching regulator 168. Therefore, in this case, the feedback loop selector 184 outputs the selected feedback voltage V_fb_sel and the selected reference voltage V_ref_sel so that the error amplifier 114 and the comparator 116 cause the control voltage D to be set, or activated. Thus, the power to the output voltage V_out is turned on, or increased. In general, this result means that V_fb_sel and V_ref_sel are selected, or generated, such that the voltage level of V_fb_sel is less than that of V_ref_sel, resulting in the comparator 116 outputting the switching control voltage V_sc as a logic high. Furthermore, the selected voltage levels for V_fb_sel and V_ref_sel, upon one of the feedback loops experiencing a triggering event, may be different for each of the feedback loops, depending on the response deemed appropriate in any given situation.

In a specific example, if only one of the feedback voltages V_fb, V_oc or V_ic is below its respective reference voltage V_ref_reg, V_ref_oc or V_ref_ic, then the feedback loop selector 184 may effectively pass through that one of the feedback voltages V_fb, V_oc or V_ic and its respective reference voltage V_ref_reg, V_ref_oc or V_ref_ic as the selected feedback voltage V_fb_sel and the selected reference voltage V_ref_sel, respectively. Alternatively, the feedback loop selector 184 may generate V_fb_sel and V_ref_sel at voltage levels designed to result in a preferred response by the error amplifier 114 and the comparator 116 (e.g. fastest response time, most efficient power usage or other preferred response characteristic), regardless of the voltage levels of the feedback voltages V_fb, V_oc or V_ic and their respective reference voltage V_ref_reg, V_ref_oc or V_ref_ic or regardless of which one of the feedback loops is experiencing the triggering event.

In another alternative, if more than one of the feedback voltages V_fb, V_oc or V_ic is below its respective reference voltage V_ref_reg, V_ref_oc or V_ref_ic (i.e. more than one of the feedback loops is experiencing a triggering event for setting the control voltage D and turning on power to the output of the switching regulator 168), then the feedback loop selector 184 may generate V_fb_sel and V_ref_sel based on a priority scheme for the feedback loops. For example, when such triggering events occur for more than one of the feedback loops, the voltage levels for V_fb_sel and V_ref_sel may preferably depend on which of these feedback loops that are experiencing the triggering events has the highest priority. For instance, in order to maintain safe operation in a battery-charging situation, it may be more important to generate V_fb_sel and V_ref_sel at voltage levels that result in the fastest possible response time than to generate V_fb_sel and V_ref_sel at voltage levels that result in the greatest power efficiency, when the output current feedback loop and either of the other two feedback loops experience a triggering event. On the other hand, when operating under battery power, it may be more important to generate V_fb_sel and V_ref_sel at voltage levels that result in the greatest power efficiency than to generate V_fb_sel and V_ref_sel at voltage levels that result in the fastest possible response time, regardless of which ones of the feedback loops experience a triggering event. Other considerations may result in different priority schemes in other embodiments.

A simplified graph 188 (solid line) of an output voltage vs. a load current for a switching regulator, e.g. 100 or 168 (FIGS. 1 and 5), incorporating an embodiment of the present invention, is shown in FIG. 8. A similar graph 190 (dash-dot-dot line) for a prior art switching regulator (not shown) is included for comparison. A graph 192 (dashed line) of a desired output voltage level is also plotted for reference.

Under light load conditions (left of point 194), the graph 190 for the prior art switching regulator is significantly offset from the desired voltage level graph 192, compared to the graph 188 for the switching regulator that incorporates an embodiment of the present invention. There is a relatively large step at point 194 in the output voltage shown in graph 190. This step is due to the prior art switching regulator transitioning between continuous and discontinuous modes at approximately the load current represented by point 194.

Although the graphs 188 and 190 are not necessarily drawn to scale, they fairly represent the relative performance results for laboratory experiments run for the switching regulator, incorporating an embodiment of the present invention, and for the prior art switching regulator. For these experiments, the desired output voltage level (graph 192) was approximately 12.57 volts. The results of the experiments showed a minimum output voltage level for the prior art switching regulator (graph 190) of about 12.57 volts and a maximum of about 12.679 volts. For the switching regulator that incorporated an embodiment of the present invention (graph 188), the minimum output voltage level was about 12.567 volts and the maximum was about 12.572 volts. According to these experiments, in other words, the prior art switching regulator (graph 190) achieved an accuracy of about 1%. On the other hand, the switching regulator that incorporated an embodiment of the present invention (graph 188) achieved an accuracy of about 0.02%. Therefore, the performance of the switching regulator that incorporated an embodiment of the present invention was significantly better than the performance of the prior art switching regulator, and significantly within the 0.5% accuracy level needed to be used in an electronic device that includes a rechargeable Li-Ion battery.

It is understood that the present invention is not limited to embodiments involving the particular values stated in the above example, since these numbers are provided for illustrative purposes only. Instead, the present invention includes embodiments for any appropriate values for these and other parameters.

The invention claimed is:

1. A switching regulator for regulating an output voltage, comprising:
an output circuit that receives an input voltage and produces the output voltage;
a comparator that causes the output circuit to turn on the output voltage when a feedback voltage falls below a first reference voltage;
an on-time timer that causes the output circuit to turn off the output voltage after a time-out period; and
an error amplifier that receives the feedback voltage and a second reference voltage and produces the first reference voltage.

2. The switching regulator of claim 1, wherein:
the first reference voltage is an offset-corrected version of the second reference voltage.

3. The switching regulator of claim 1, wherein the aforementioned feedback voltage is a selected feedback voltage, further comprising:
a feedback loop selector that receives feedback through multiple feedback loops and produces the selected feedback voltage based on the multiple feedback loops.

4. The switching regulator of claim 3, wherein:
the aforementioned second reference voltage is a selected reference voltage; and
the feedback loop selector produces the selected reference voltage based on the multiple feedback loops and multiple reference voltages.

5. The switching regulator of claim 3, wherein:
the multiple feedback loops supply, to the feedback loop selector, voltages that are representative of the output voltage, an output current and an input current.

6. The switching regulator of claim 1 having a transient response time of about 100 nanoseconds or faster.

7. The switching regulator of claim 1 having a regulation accuracy of about 0.5% or less.

8. The switching regulator of claim 1, wherein the output circuit includes a switching half bridge.

9. A method of regulating a voltage comprising:
generating an initial reference voltage with which an output voltage is to be regulated;
generating, by an error amplifier, a corrected reference voltage having an offset correction based on a feedback voltage and the initial reference voltage;
turning on a switching signal based on the corrected reference voltage and the feedback voltage;
turning off the switching signal after an on-time period;
generating the output voltage from an input voltage regulated by the switching signal.

10. The method of claim 9, wherein the aforementioned feedback voltage is a selected feedback voltage, further comprising:
generating the selected feedback voltage based on multiple feedback loops.

11. The method of claim 10, wherein the aforementioned initial reference voltage is a selected reference voltage, further comprising:
generating the selected reference voltage based on the multiple feedback loops and multiple reference voltages.

12. The method of claim 10, further comprising:
generating, by the multiple feedback loops, voltages that are representative of the output voltage, an output current and an input current.

13. The method of claim 9, further comprising:
regulating the output voltage with a transient response time of about 100 nanoseconds or faster.

14. The method of claim 9, further comprising:
regulating the output voltage with a regulation accuracy of about 0.5% or less.

15. The method of claim 9, wherein the generating of the output voltage further comprises generating the output voltage with a switching half bridge.

16. A switching regulator for regulating an output voltage, comprising:
a means for generating the output voltage;
a means for producing a selected feedback voltage based on multiple feedback loops;
a means for generating an offset-corrected reference voltage based on the selected feedback voltage and an initial reference voltage, with which the output voltage is regulated;
a means for determining when the selected feedback voltage is below the offset-corrected reference voltage;
a means for causing the output voltage generating means to increase the output voltage when the selected feedback voltage is below the offset-corrected reference voltage;
a means for timing a minimum period of time; and
a means for causing the output voltage generating means to decrease the output voltage when the timing means times out.

17. The switching regulator of claim 16, wherein the aforementioned initial reference voltage is a selected reference voltage, further comprising:
a means for producing the selected reference voltage based on the multiple feedback loops and multiple reference voltages.

18. The switching regulator of claim 16, further comprising:
a means for generating, by the multiple feedback loops, voltages that are representative of the output voltage, an output current and an input current.

19. The switching regulator of claim 16 having a transient response time of about 100 nanoseconds or faster.

20. The switching regulator of claim 16 having a regulation accuracy of about 0.5% or less.
